(19) United States
(12) Patent Application Publication
(10) Pub. No.: US 2024/0402651 A1
(43) Pub. Date: Dec. 5, 2024

(54) LIGHTWEIGHT AND ROBUST TIMEPIECE COMPONENT

(71) Applicant: ROLEX SA, Geneva (CH)

(72) Inventors: Bruno Lisiecki, Annecy (FR); Christophe Mondoux, Geneva (CH)

(73) Assignee: ROLEX SA, Geneva (CH)

(21) Appl. No.: 18/679,176

(22) Filed: May 30, 2024

(30) Foreign Application Priority Data
Jun. 1, 2023 (EP) 23176779.9

(51) Int. Cl. G04B 45/00; G04B 37/22; G04D 3/00

(52) U.S. Cl. CPC G04B 45/0076; G04B 37/22; G04D 3/0069; G04D 3/0097

(57) ABSTRACT

Component, in particular a timepiece component, which has at least one porous core that includes a first material or based on a first material, having a relative density less than or equal to 80%, or less than or equal to 60%, or less than or equal to 50%, of the relative density of the first material in solid form, the at least one porous core having at least one area for which its porosity at its surface is lower than its porosity away from its surface.

### CROSS-REFERENCE TO RELATED APPLICATION

This application claims priority of European patent application No. EP23176779.9 filed Jun. 1, 2023, the content of which is hereby incorporated by reference herein in its entirety.

### BACKGROUND ART

The present invention relates to a timepiece component, in particular a decorative timepiece component, or more generally any other component, including outside the field of timepieces. It also relates to a timepiece, in particular a wristwatch, comprising at least one such timepiece component. It also relates to a method for manufacturing such a timepiece component.

A timepiece component, and more specifically a decorative timepiece component, must combine many mechanical properties that are sometimes contradictory. For example, it must be:
Lightweight, so that the timepiece is comfortable to wear;
Very stylish, as well as flawless, to meet the high aesthetic standards of luxury timepieces;
Robust, to withstand the external stresses to which a timepiece is exposed, such that the timepiece component retains the same appearance, and more generally all of its mechanical properties, for all time.

### SUMMARY OF THE INVENTION

In practice, existing solutions amount to a compromise between these properties. Timepiece components are thus generally produced as a solid piece, from a material which may be both lightweight and hard. These existing solutions do however have limitations and there is a need to identify new solutions making it possible to optimize the properties and/or the appearance of timepiece components.

It is thus an aim of the present invention to propose a solution for obtaining a component, notably a timepiece component, which is lightweight and robust, offering an improvement over the prior art.

To this end, the invention is based on a component, in particular a timepiece component, which comprises at least one porous core, comprising a first material or based on a first material, having a relative density less than or equal to 80%, or less than or equal to 60%, or less than or equal to 50%, of the relative density of the first material in solid form, and wherein the at least one porous core has at least one area for which its porosity at its surface is lower than its porosity away from its surface.

The invention is also based on a method for manufacturing a component, in particular a timepiece component, which comprises a step of producing a porous core, comprising a first material or based on a first material, having a relative density less than or equal to 80%, or less than or equal to 60%, or less than or equal to 50%, of the relative density of the first material in solid form, the porous core having at least one area for which its porosity at its surface is lower than its porosity away from its surface.

The invention is defined more specifically by the claims.

### BRIEF DESCRIPTION OF THE DRAWINGS

These aims, features and advantages of the present invention will be disclosed in detail in the description below of particular non-limiting embodiments, which are described with reference to the attached figures in which:

FIG. 1 depicts elementary lattice structures obtained by a first step of a method for manufacturing a component, in particular a timepiece component, according to an embodiment of the invention.

FIG. 2 depicts elementary structures of TPMS (Triply Periodic Minimal Surface) type obtained by the first step of a method for manufacturing a component, in particular a timepiece component, according to another embodiment of the invention.

FIGS. 3a and 3b depict the porous cores of a watch middle case resulting from the first step of the method for manufacturing a timepiece component respectively according to two variants of the embodiment of the invention.

FIGS. 4a and 4b depict two views of the porous core of a blank for a middle case resulting from the first step of the method for manufacturing a timepiece component according to a third variant of the embodiment of the invention.

### DETAILED DESCRIPTION OF PARTICULAR EMBODIMENTS

The concept of the invention consists in proposing a component comprising at least one porous core, which is very lightweight, but robust. Notably, the timepiece component may be in essence a porous core. According to a particular version of the invention, at least one portion or region of the component could have a porous core, with the rest of the timepiece component having any other architecture, in particular conventional. Moreover, the component comprises all or part of its surface, in other words at least one area in which it has a porosity which is lower at its surface than a porosity measured further toward the inside of the component, away from its surface.

In any case, the result is a component for which there is no need for compromise, since it is as lightweight as possible while being extremely robust, and optionally very hard, at least in said area of reduced surface porosity. In addition, advantageously, the surface finish of the component is such that it has a very attractive appearance. Optionally, the component may comprise a surface coating taking the form of a decorative layer, notably a fine decorative surface layer. In a variant embodiment, the layer may be hard, particularly based on a ceramic-metal composite or based on a polymer-ceramic composite.

Note that, throughout the text, the expression “based on a material” will be used to indicate the fact that the content of said material is principal or majority. Particularly, the expression “based on a material” will be used to indicate the fact that for instance the content of said material is at least 50% by weight.

A method for manufacturing a timepiece component according to an embodiment of the invention will now be described in detail.

The method first of all comprises a first step of producing a porous core, made of a first material or based on a first material, having a relative density less than or equal to 80%, or less than or equal to 60%, or less than or equal to 50%, of the relative density of the first material in solid form. The relative density of the porous core is thus particularly low with regard to the relative density of the first material in solid form. The relative density in question is the overall or average relative density of the porous core.

This first step may be carried out by means of several variant embodiments of the method.

According to a particular variant embodiment, the step of producing the porous core comprises a step of chemical attack of a solid blank made of the first material. In this first variant embodiment, the first step of the method therefore comprises a first sub-step of producing a solid blank of the core of the timepiece component, made of the first material or based on the first material. The first step of the method then comprises a second sub-step of chemical attack of the solid blank made of the first material, so as to form as a result a porous core. Such a porous core May then take the form of a foam, for example a metallic foam.

According to another particular variant embodiment, the step of producing the porous core may be based on the formation of bubbles in a liquid metal that is subsequently solidified in the form of a metallic foam.

According to yet another particular variant embodiment, the step of producing the porous core may be based on a technique of infiltration of a liquid metal into a porous body formed of a molding material. After solidification of the metal, the molding material forming the porous body is removed.

According to yet another particular variant embodiment, the step of producing the porous core comprises a step of additive manufacturing, so as to directly form a porous core made of the first material or based on the first material. For example, the technique of powder bed fusion makes it possible to produce a controlled architecture, with a precise structure and a good definition of the opening of the pores and good control of the anisotropy.

In all cases, the porous core has a relative density less than or equal to 80%, or less than or equal to 60%, or less than or equal to 50%, of the relative density of the first material in solid form. In other words, the porous core has a mass less than or equal to 80%, or less than or equal to 60%, or less than or equal to 50%, relative to the mass of a body occupying the same volume as the porous core of the timepiece component and forming a solid piece made wholly of the same first material.

The porous core may present numerous aspects according to the invention. For example, it may be a porous core having a type of skeleton made up of a regular or irregular porous framework, in particular of lattice type, or structures known as TPMS (Triply Periodic Minimal Surface), or indeed alveolar, cellular or trabecular structures. In particular, the porous core may for example be made of metallic foam.

The porous core may comprise a multitude of materials. For example, it may be a porous core comprising a first material or based on a first material in the form of a metal or a metal alloy, or a metal superalloy, in particular comprising one or more of the following elements: Fe, Mg, Al, Ti, Au, Pd, Pt, Ni, Si, and/or Co. This first material may also be an amorphous or partially amorphous alloy, or a ceramic, for example a ceramic based on alumina or zirconia.

According to a variant embodiment of the porous core, it may be made up of several different materials. Preferably, the porous core is based on a first material as described above, in other words the structure formed by this first material is that having the greatest weight in the porous core as a whole, and preferably takes up at least 50% by weight of the porous core. In a variant embodiment with several materials, the porous core may comprise different materials organized in layers between the center of the porous core and the surface of the porous core. In this particular variant, the porous core has in all cases a porous structure of several materials, and the relative density of the porous structure formed by all of said materials is less than or equal to 80%, or less than or equal to 60%, or less than or equal to 50%, of the relative density of the same structure as a solid piece wholly formed of said first material.

In this document, the relative density of the porous core corresponds to the average relative density of the skeleton as a whole formed by the porous core and not to the relative density of the first material or of the materials constituting the core. Thus, the relative density of the porous core is a function of the porosity or of the degree of porosity of the porous core.

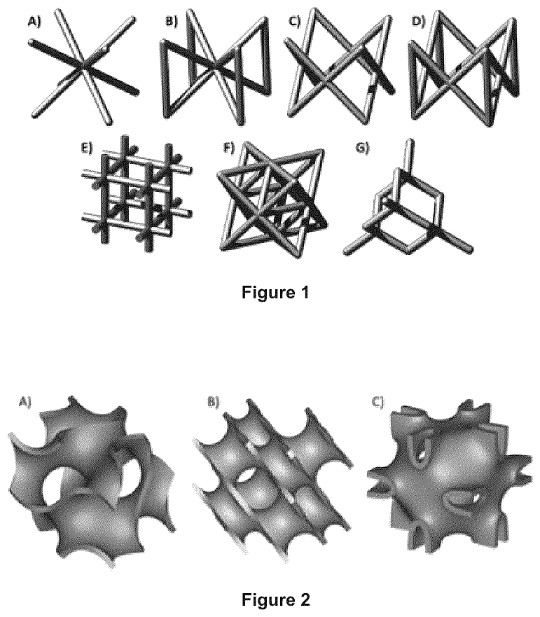

To this end, FIG. 1 depicts, by way of examples, elementary structures having different lattice structures which may be utilized in this first step of producing a porous core. FIG. 2 likewise depicts several elementary structures with TPMS structures which may be produced in the context of the first step of the method.

According to an exemplary embodiment, the porous core may be a foam having a random structure, in other words comprising pores with random positions and dimensions, in an irregular manner. According to another exemplary embodiment, the porous core may have a regular, non-random structure, such as for example a three-dimensional framework (“lattice”), having a structure forming a repetitive framework. This is the case of the abovementioned lattice structures.

The structure may thus be selected so as to obtain maximum porosity while offering considerable mechanical strength.

According to a variant embodiment, the porous core is designed not only to minimize the overall weight but also to fulfill one or more other functions. For example, it may be designed to afford optimal mechanical strength in certain areas likely to experience the highest mechanical stresses or strain. Thus, the structure of the porous core may be optimally equipped to cope with these high stresses, being adapted to withstand these high stresses, for example by virtue of a particular non-homogeneous distribution of the first material forming or comprised in the porous core, in such a way as to form mechanical reinforcements in the areas concerned. Regarding other mechanical functions that may be taken into account when designing the structure of the porous core, especially if the timepiece component is a watch middle case or case, provision may notably be made for areas adapted to absorb impacts (to insulate a watch movement within a housing or case, for example), areas for assembling said timepiece component with other components (for assembling a watch movement within a case or a middle case, for example), areas for reinforcing sealing of the timepiece component, or indeed areas for transmission of sound (for transmitting a sound coming from a watch movement, for example). Alternatively or in addition, provision may also be made for flexible areas, to allow elastic deformation of the timepiece component, in particular in the case of a timepiece component for example in the form of a cover plate of a bracelet clasp. These flexible areas may also be used for assembling said timepiece component with other components.

According to the invention, the porous core may comprise pores of smaller size close to its surface in relation to its center, so as to have at the surface a particularly attractive geometry, possibly denser and/or harder than away from its surface. More generally, the porous core may thus have a non-homogeneous structure, in particular with a difference between its center and its surface, in particular a non-homogeneous porosity. This difference may consist of a gradient of the dimension of the pores, which increases from the surface to the center. Notably, the surface of the porous core or a given layer of the porous core may be without pores, or have very few pores. In addition or alternatively, a possible layer may be formed at the surface of the core so as to constitute a skin making it possible to close off the pores present on said surface, or close to said surface. All or some of the variants of porous cores described above may of course be combined. A porous core with this geometry makes it possible to form a component that is lightweight but has an attractive surface appearance, less porous than at its center, optionally dense and not porous at the surface, and optionally relatively hard, harder than at its center. Said surface of the porous core may be an outer surface, particularly a visible surface, of the porous core, corresponding to an outer surface of the timepiece component.

Said surface of the porous core may be an outer surface. Indeed, the structure may be designed to optimize adhesion of a surface coating taking the form of a decorative layer, notably a fine decorative surface layer.

In particular, it is thus possible to obtain a timepiece component, in particular a middle case or case, in which the outer surface is optionally covered with such a decorative layer, which may for example be deposited by a method of physical vapor deposition (PVD), or chemical vapor deposition (CVD), or atomic layer deposition (ALD). For example, a layer, deposited on the core for example by PVD, and intended to exhibit a particular appearance or color, may be added on the first layer, for example with a thickness preferably of between 500 nm and 20 μm of a metal or of a metal alloy, for example of Au, Ag, Pt, Pd type. One advantage of this surface coating lies in the fact that it makes it possible to form a decorative layer, which meets the high standards of luxury timepieces. Furthermore, the surface coating may in particular be designed to have an attractive look, in particular a color or an effect that may not be achievable with the first material.

According to a variant embodiment, the manufacturing method advantageously makes it possible to create a transition area at the interface between the porous core and the optional surface coating, which comprises the respective materials of the porous core and the surface coating mixed in together, so as to optimize the adhesion of the surface coating.

According to a variant embodiment, the manufacturing method may also comprise a step of filling most, or even all or almost all of the pores of the porous core with a given material. In such a case, the porous core is still defined as the structure in question not including the filling material, the component consisting of the combination of the porous core and the filling material. The latter is advantageously a resilient material such as a polymer.

Advantageously, such a step of filling the pores makes it possible to propose a component according to the invention which is moreover equipped with a core comprising a material making it possible to dissipate impacts and thus to optimally preserve the skeleton formed by the porous core.

In all cases, the manufacturing method may implement an optional additional step, of intermediate laser or heat or mechanical treatment, the function of which is to densify the surface of the porous core, in particular by closing off at least some of the pores at the surface of the porous core. This may for example be a sand-blasting operation or an operation using a laser, notably a picosecond or femtosecond laser. Another additional treatment may consist in increasing the surface roughness of the porous core. Yet another additional treatment may consist in washing or cleaning or a plasma treatment or deposition of an adhesion promoter. More generally, the additional step may be envisaged to improve or control the surface of the porous core. In all cases, the method makes it possible to form, in at least one area of the component, a surface having a porosity that is reduced relative to the porosity away from said surface of the porous core.

The manufacturing method may then comprise complementary treatments, which are optional.

In particular, the method may implement an optional finishing step, in particular as regards the surface state and/or the color of at least a part of the surface of the porous core, or of the surface of a coating layer, so as to give it a particular aesthetic appearance and optimizer its final geometry, by eliminating for example any surface defects. Such a step may furthermore give the surface a particular functionality. Such a step may be a step of grinding and/or polishing and/or microbead-blasting and/or finishing and/or decoration and/or coloration. It may be performed mechanically and/or electrochemically and/or by optical means, for example using a picosecond or femtosecond laser. Various techniques may thus be combined in order to implement this finishing step. It thus makes it possible for example to obtain a timepiece component having a final surface state of textured, polished, sand-blasted or satin type, and/or having a specific color, or a combination of these states.

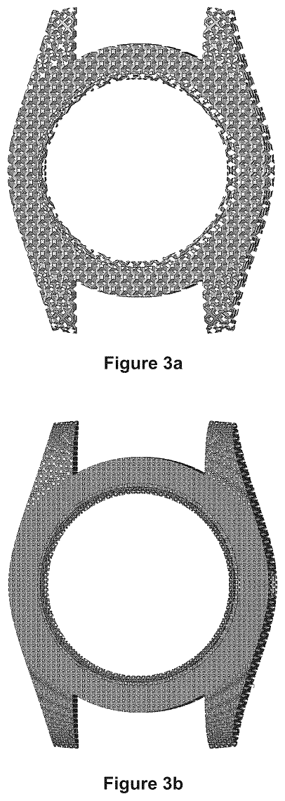

FIGS. 3a and 3b depict the application of the first step of the manufacturing method according to the invention in the context of particular examples of the manufacture of a case for a wristwatch. FIGS. 3a and 3b thus depict the porous core of a watch case, resulting from the first step of the method, according to two variant embodiments. In both cases, this porous core is produced by additive manufacturing using a first material, which is titanium, in a mesh structure with a respective mesh size of 500 μm (FIGS. 3a) and 200 μm (FIG. 3b). The corresponding degree of porosity is 70% and 48% respectively. The density is 1.6 g/cm3 and 2.3 g/cm3 respectively. Note that, as a variant, instead of titanium the first material used could be magnesium Mg or aluminum Al or an alloy based on Mg or an alloy based on Al or an alloy based on Ti, in such a way as to obtain a porous core having the same structure but which is even more lightweight. To be specific, with a Mg alloy having a density of 1.7 g/cm3 and a porosity of around 50%, it is possible to obtain a porous core with an apparent density of 0.80-0.85 g/cm³. It is also possible to envisage the use of precious alloys based on gold (Au), or palladium (Pd), or platinum (Pt), so as to obtain a component made of precious metal with a relative density strictly lower than that of the alloy in solid form. Furthermore, it is also possible to envisage the use of a ceramic, such as a zirconia, so as to obtain a component made of ceramic with a relative density strictly lower than that of said ceramic.

The invention relates more generally to a component, in particular a timepiece component, obtained by a manufacturing method according to the invention, which is of course not limited to the above description.

Thus, the invention makes it possible to form any component, in particular any timepiece component, comprising a porous core comprising a first material, the porous core having a relative density less than or equal to 80%, or less than or equal to 60%, or less than or equal to 50%, of the relative density of the first material in solid form, the at least one porous core having at least one area for which its porosity at its surface is lower than its porosity away from its surface.

All or part of the surface of the porous core, in particular at least in one area of the porous core, is in particular designed to have a high relative density. Thus, the relative density of the surface of the porous core may be in particular greater than or equal to 90%, or greater than or equal to 99%, of the relative density of the first material in solid form.

Thus, advantageously, the surface of the porous core may have a degree of porosity of less than or equal to 0.5%, or less than or equal to 0.1%, or less than or equal to 0.05%, or less than or equal to 0.01%. Note that the degree of porosity has both aesthetic and functional consequences. Depending on the size of the defects arising from the porosity, a polished surface will for example highlight the porosity, which may be manifested by an irregular light reflection at the edge. Moreover, the porosity may be detrimental to the functionality of the surface and render it permeable, and hence ineffective as a protective barrier (against heat, chemicals, etc.). It is thus beneficial to obtain a surface of the component having a low porosity, and optionally a surface of the porous core having a porosity as low as possible.

Furthermore, the surface of the porous core may have a thickness sufficient to contribute to the robustness of the finished timepiece component. The thickness of the surface of the porous core means the thickness of the area having a high relative density and/or a low porosity, in particular the area at the surface the relative density of which is greater than or equal to 90%, or greater than or equal to 99%, of the relative density of the first material in solid form, and/or the area at the surface the degree of porosity of which is less than or equal to 0.5%, or less than or equal to 0.1%, or less than or equal to 0.05%, or less than or equal to 0.01%. Naturally, the area in which the surface of the porous core has a low porosity is located over a certain thickness from the outer surface of the porous core. Advantageously, this thickness is very small so as to ensure that the component is as lightweight as possible, which advantageously means that the term “surface” can be applied in this context even though the measurement is carried out over a volume. Advantageously, this thickness is between 1 and 500 μm, or between 10 and 200 μm, or between 20 and 100 μm on the finished timepiece component after the surface has undergone any treatments, such as for example a grinding, finishing and/or polishing treatment. It is measured disregarding any surface coating optionally added to the surface of the porous core. Moreover, this surface of the porous core may have a textured, polished, sand-blasted or satin surface finish. After such a surface treatment, the resulting thickness of the surface of the porous core may be lower than that obtained initially: for example, in the case of a surface of a porous core having a thickness between 150 and 200 μm, mechanical polishing or laser texturing may reduce this final thickness to around 80 μm.

The surface of the porous core is optionally designed to be very hard. It may thus have a surface hardness of greater than or equal to 300 HV, or greater than 500 HV, or greater than or equal to 600 HV, or greater than or equal to 900 HV. Alternatively or in addition, the surface of the porous core is optionally designed to have an attractive look, in particular a color or an effect which may not be achievable by the porous core formed from the first material.

As stated above, the manufacturing method advantageously makes it possible to create a transition area at the interface between the porous core and the surface of the porous core, so as to optimize the properties and/or the adhesion of the surface of the porous core.

An optional surface coating may comprise a second material, which may be identical or different to the first material.

The method described above has the advantage of being compatible with a great many materials. For example, the first material of the porous core may be a metal or a metal alloy, or a metal superalloy, in particular comprising one or more of the following elements: Fe, Mg, Al, Ti, Au, Pd, Pt, Ni, Si, and/or Co. This first material may also be an amorphous or partially amorphous alloy or a polymer, or a ceramic, for example a ceramic based on alumina or zirconia.

The invention is particularly suitable for any component, notably for any timepiece component, in particular for any decorative component, such as a component taking the form of a watch middle case or a bracelet.

Moreover, according to a particular version of the invention, at least one portion or region of the component, in particular of the timepiece component, could have a porous core according to the invention, with the rest of the component having any other architecture, in particular conventional. Thus, the invention also relates to a timepiece component which comprises a partially porous core, in other words a core which is porous only in certain portions, or several porous cores connected to one another by one or more non-porous portions. As a variant, the timepiece component could comprise a core made up of several porous portions that are different in terms of the structure of their porosity and/or in terms of their material or materials. In all cases, the timepiece component thus comprises at least one porous core. In other words, the core of the timepiece component may be wholly or partially composed of said at least one porous core.

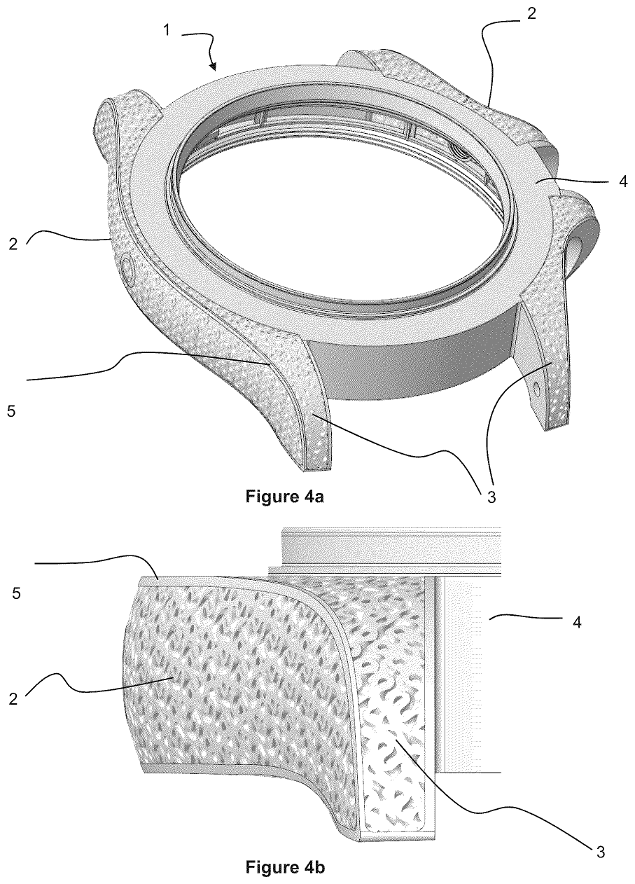

By way of example, FIGS. 4a and 4b depict a blank for a middle case 1 having portions forming porous cores. These portions may for example prefigure sides 2 or lugs 3 of a case. These porous cores comprise a first material or are based on a first material having a relative density less than or equal to 80%, or less than or equal to 60%, or less than or equal to 50% of the relative density of the first material in solid form. Note that the porous cores of these embodiments according to FIGS. 4a and 4b include solid, non-porous edges 5 for forming reinforced areas in places that are subject to high stresses or are considerably exposed. Other surface areas, advantageously the entire surface of these porous cores, will be treated according to the invention so as to obtain a surface of low porosity, as described above.

The invention also relates to a timepiece, in particular a wristwatch, which comprises at least one such timepiece component.

Lastly, the invention thus makes it possible to combine two major aims for a component, in particular a decorative timepiece component, which were hitherto not achieved. It makes it possible to obtain both a lightweight component and a mechanically robust component, having a surface with satisfactory properties, namely one which is strong and/or hard and/or attractive. It is also possible to treat the surface of low porosity of the porous core or an optional decorative coating deposited on this surface, for example by means of laser texturing, and/or to obtain surface states and finishes such as sanded, satin or polished.

The invention has been described with reference to a timepiece component. Clearly, it could also be used in any other field, for example automotive, aeronautical, space, medical, etc., in which it is useful to have lightweight and robust components.

1. A component, which comprises:
at least one porous core, comprising a first material or based on a first material, having a relative density less than or equal to 80% of the relative density of the first material in solid form,
wherein the at least one porous core has at least one area for which a porosity at a surface of the at least one porous core is lower than a porosity away from the surface of the at least one porous core.

2. The component as claimed in claim 1, wherein the lower porosity of the at least one area extends at the surface over a thickness measured from an outer surface of the at least one porous core, not including an optional surface coating, in a range of from 1 to 500 μm.

3. The component as claimed in claim 1,
wherein the first material of the at least one porous core is a metal or a metal alloy or a metal superalloy, and/or
wherein the first material of the at least one porous core is an amorphous or partially amorphous alloy, or is a polymer, or is a ceramic.

4. The component as claimed in claim 1, wherein the at least one porous core is a metallic foam or is a skeleton made up of a regular or irregular porous framework.

5. The component as claimed in claim 1,
wherein a degree of porosity at the surface of the at least one area is less than or equal to 0.5%, and/or
wherein a relative density at the surface of the at least one area is greater than or equal to 90% of a relative density of the first material in solid form.

6. The component as claimed in claim 1, wherein a surface hardness of the at least one area is greater than or equal to 300 HV.

7. The component as claimed in claim 1,
wherein the at least one porous core has pores at the surface of the at least one area and pores away from the surface, wherein the pores at the surface of the at least one area have a dimension less than or equal to a dimension of the pores away from the surface, and/or
wherein the surface of the at least one area is without pores, and/or
wherein the component comprises a non-homogeneous porosity over a thickness between the surface of the component and the at least one core in the at least one area, which increases from the surface to the center.

8. The component as claimed in claim 1, wherein the at least one porous core comprises pores, and wherein most of the pores of the at least one porous core are filled with a filling material.

9. The component as claimed in claim 1, comprising a surface coating forming a decorative layer of a metal or of a metal alloy, arranged on the surface of the at least one area.

10. The component as claimed in claim 1, which is a decorative timepiece component, such as a component taking the form of a watch case or a bracelet.

11. A timepiece, which comprises at least one component as claimed in claim 1.

12. A method for manufacturing a component, wherein the method comprises:
producing at least one porous core, comprising a first material or based on a first material, having a relative density less than or equal to 80% of a relative density of the first material in solid form, the at least one porous core having at least one area for which a porosity at a surface of the at least one area is lower than a porosity away from the surface of the at least one area.

13. The method as claimed in claim 12, wherein the producing of the at least one porous core comprises:
performing chemical attack of a solid blank made of the first material or based on the first material,
performing additive manufacturing, forming the at least one porous core made of metallic foam or having a shape of a skeleton made up of a regular or irregular porous framework.

14. The method as claimed in claim 12, wherein the method comprises:
performing laser or heat or mechanical treatment to densify the surface of the at least one area of the at least one porous core.

15. The method as claimed in claim 12, wherein the method comprises:
subsequently performing grinding and/or polishing and/or microbead-blasting and/or decorating, so as to obtain a final surface state of textured, polished, sand-blasted or satin aspect of the surface of the component.

16. The method as claimed in claim 14, wherein the laser or heat or mechanical treatment to densify the surface of the at least one area of the at least one porous core comprises closing off at least some of the pores at the surface of the at least one porous core.

17. The method as claimed in claim 16, wherein the closing off of at least some of the pores at the surface of the at least one porous core comprises sand-blasting or performing a laser treatment.

18. The method as claimed in claim 16, wherein the closing off of at least some of the pores at the surface of the at least one porous core comprises performing a laser treatment with a picosecond or femtosecond laser.

19. The component as claimed in claim 3,
wherein the metal or the metal alloy or the metal superalloy of the first material of the at least one porous core comprises Fe, Mg, Al, Ti, Au, Pd, Pt, Ni, Si, and/or Co, and/or
wherein the first material of the at least one porous core is a ceramic based on alumina or zirconia.

20. The component as claimed in claim 4, wherein the porous framework is a lattice, TPMS, alveolar, cellular or trabecular framework.
